(19) United States
(12) Patent Application Publication
(10) Pub. No.: US 2015/0033570 A1
(43) Pub. Date: Feb. 5, 2015

(54) PIPE MEASUREMENT DEVICE

(71) Applicant: Javier BERNABE, Orlando, FL (US)

(72) Inventor: Javier BERNABE, Orlando, FL (US)

(21) Appl. No.: 14/311,197

(22) Filed: Jun. 20, 2014

Related U.S. Application Data
(60) Provisional application No. 61/861,191, filed on Aug. 1, 2013.

(51) Int. Cl. G01B 3/42

(52) U.S. Cl. CPC G01B 3/42
USPC 33/555.1

(57) ABSTRACT

A pipe measurement device may include a base having a first side, a second side, a bottom side, a top side, and a thickness. The second side of the base may include a plurality of cutouts. A pipe may be placed within the plurality of cutouts until the pipe may fit into and substantially occupy the matching cutout. A marking indication may be viewed and read adjacent to the matching cutout to confirm the size of the diameter. The first side of the base may include a measuring edge. The pipe measurement device may be used for pipes such as those used in residential air conditioning units.

### CROSS-REFERENCE TO RELATED APPLICATION

This application claims the benefit of U.S. provisional application No. 61/861,191, filed Aug. 1, 2013, the contents of which are herein incorporated by reference.

### BACKGROUND OF THE INVENTION

The present invention relates to pipe measurements and, more particularly, to a pipe measurement device.

During construction and home improvement projects, the correct piping size can be important. Pipe size selection may be incorrect depending on the process a person may use to pick the pipe. These processes may include a trial and error approach that can be time consuming.

As can be seen, there is a need for a pipe measurement device to provide physical and visual confirmation of the pipe size.

### SUMMARY OF THE INVENTION

In one aspect of the present invention, a pipe measurement device comprises: a base having a first side, a second side, a bottom side, a top side, and a thickness, wherein the second side comprises a plurality of cutouts, wherein indicia is disposed on the top side of the base adjacent to each cutout.

In another aspect of the present invention, a method for measuring a pipe using a pipe measurement device comprising: a base having a first side, a second side, a bottom side, a top side, and a thickness, wherein the second side comprises a plurality of cutouts, comprises the steps of: placing a pipe into the plurality of cutouts until the pipe fits into and substantially occupies the matching cutout; and reading the marking indication from the matching cutout.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a top view of an exemplary embodiment of the present invention;

FIG. 3 is a side view of an exemplary embodiment of the present invention; and

FIG. 4 is a section view of an exemplary embodiment of the present invention taken along line 4-4 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pipe measurement device that may include a base having a first side, a second side, a bottom side, a top side, and a thickness. The second side of the base may include a plurality of cutouts. A pipe may be placed within the plurality of cutouts until the pipe may fit into and substantially occupy the matching cutout. An indicia may be viewed and read adjacent to the matching cutout to confirm the size of the diameter. The first side of the base may include a measuring edge.

The present invention may be used for sizing pipes, such as residential air conditioning unit copper pipes, or the like. A pipe may be placed within one of a plurality of cutouts along a second side of the device. The pipe may fit into, and substantially occupy a particular cutout area, which may designate the size of that particular pipe. The device may be used as an additional measuring device with measurements shown on a first side of the device.

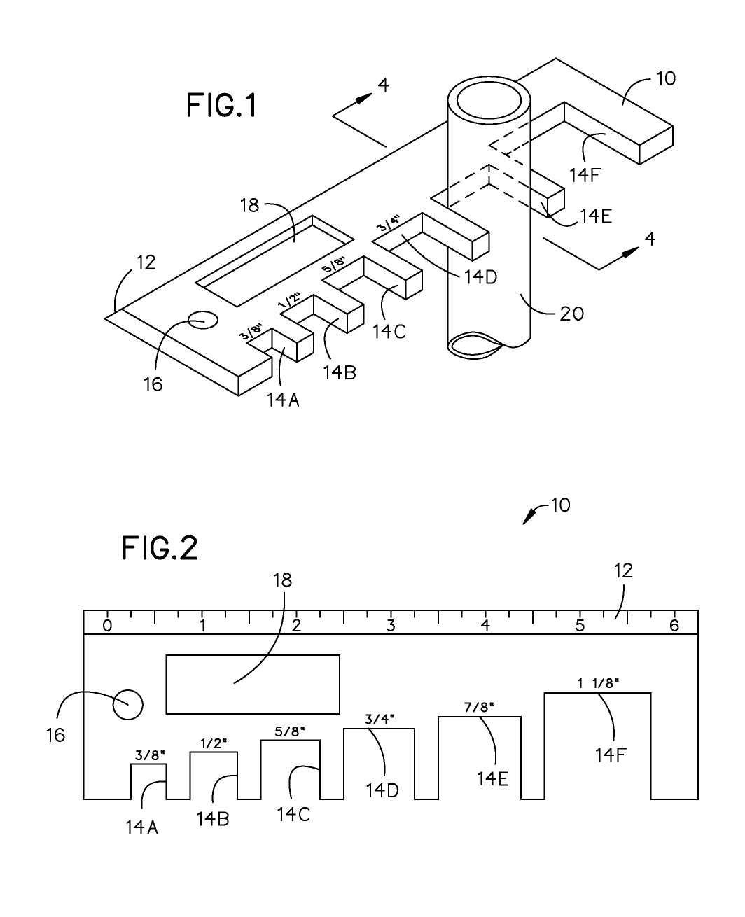

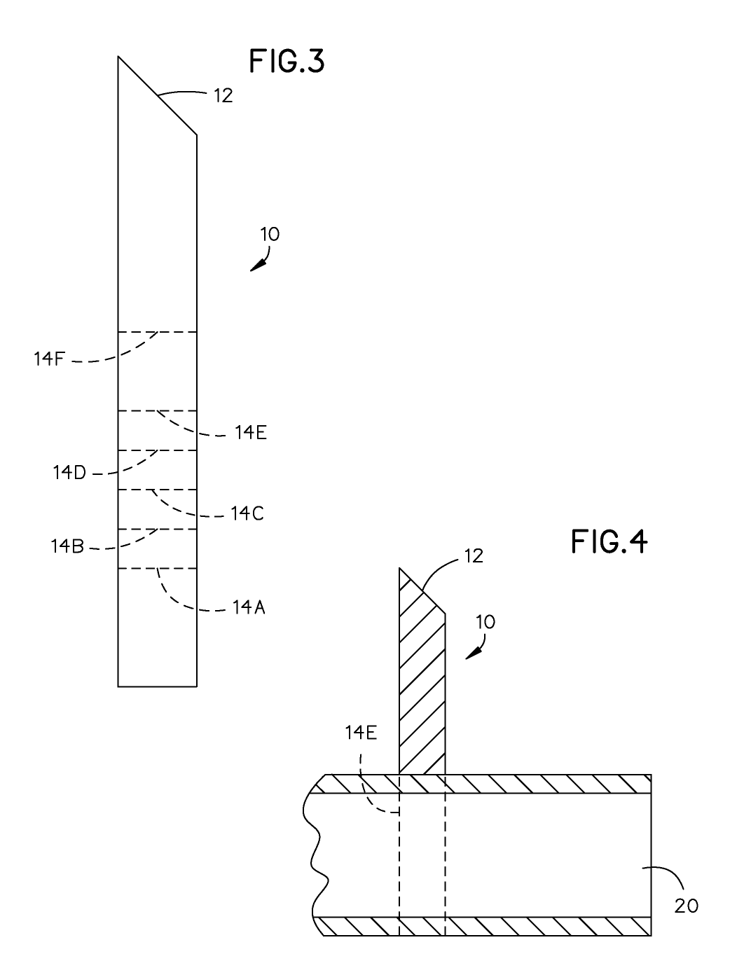

As is illustrated in FIGS. 1 through 4, a pipe measurement device 10 may include a base 11 having a first side, a second side, a bottom side, a top side, and a thickness. The base 11 may be substantially rectangular cuboid in shape. The first side of the base 11 may include a measuring edge 12. The measuring edge 12 may be along an angle so that the bottom side of the base 11 may extend out farther than the top side of the base 11. The measuring edge 12 may have marking indications for measurement, such as inches or the like. The second side of the base 11 may include a plurality of cutouts. In certain embodiments, the plurality of cutouts may include an approximately ⅜″ sized cutout 14A, an approximately ½″ sized cutout 14B, an approximately ⅝″ sized cutout 14C, an approximately ¾″ sized cutout 14D, an approximately ⅞″ sized cutout 14E, an approximately 1-⅛″ sized cutout 14F, and the like. The plurality of cutouts may be approximately square in shape so that each side of the cutout may have approximately the same length. However, the plurality of cutouts may each be any shape as long as the shape facilitates determining the size of a pipe that may fit into the individual cutout. In certain embodiments, the plurality of cutouts may have approximately ⅛″ of material of the base 11 in between each cutout.

In certain embodiments, the base 11 may also include a logo area 18. A hole 16 through the top side of the base 11 through to the bottom side of the base 11 may allow for the display of the device in a store. The device 10 may be made from plastic mold or the like. The thickness of the device may vary.

A method of using the pipe measurement device 10 may include the following. A person may place the device 10 on top of a copper pipe 20, an iron pipe 20 or the like, in order to confirm, verify or to know the proper measurement of the pipe 20. The pipe 20 may placed within one of the plurality of cutouts until the pipe 20 may fit into and substantially occupy the appropriate cutout. The marked indicia for that particular cutout may determine and identify the diameter of the pipe 20.

It should be understood, of course, that the foregoing relates to exemplary embodiments of the invention and that modifications may be made without departing from the spirit and scope of the invention as set forth in the following claims.

What is claimed is:

1. A pipe measurement device comprising:
a base having a first side, a second side, a bottom side, a top side, and a thickness, wherein the second side of the base comprises a plurality of cutouts, wherein indicia is disposed on the top side of the base adjacent to each cutout.

2. The pipe measurement device of claim 1, wherein the base is substantially rectangular cuboid in shape.

3. The pipe measurement device of claim 1, wherein the first side of the base comprises a measuring edge having marking indications for measurement.

4. The pipe measurement device of claim 1, wherein the plurality of cutouts comprises an approximately ⅜″ sized cutout, an approximately ½″ sized cutout, an approximately ⅝″ sized cutout, an approximately ¾″ sized cutout, an approximately ⅞″ sized cutout, and an approximately 1-⅛″ sized cutout.

5. The pipe measurement device of claim 1, wherein the measuring edge is angled, wherein the bottom side of the base extends out farther than the top side of the base.

6. The pipe measurement device of claim 1, wherein the base further comprise a hole cutting through the top side to the bottom side.

7. A method for measuring a pipe using the pipe measurement device of claim 1, comprising the steps of:
placing a pipe into the plurality of cutouts until the pipe fits into and substantially occupies the matching cutout; and
reading the indicia disposed on the top side of the base adjacent to the matching cutout.

8. The method of claim 7, wherein the base is substantially rectangular cuboid in shape.

9. The method of claim 7, wherein the first side of the base comprises a measuring edge.

10. The method of claim 7, wherein the plurality of cutouts comprises a ⅜″ sized cutout, an approximately ½″ sized cutout, an approximately ⅝″ sized cutout, an approximately ¾″ sized cutout, an approximately ⅞″ sized cutout, and an approximately 1-⅛″ sized cutout.
